(19) United States
(12) Patent Application Publication
(10) Pub. No.: US 2007/0098855 A1
(43) Pub. Date: May 3, 2007

(54) SaltBeauty : Ornamental Kitchen Salt Container and Dispenser

(76) Inventor: ANITA RATAN RAMAIAH, SCOTTSDALE, AZ (US)

Correspondence Address: VENABLE, CAMPILLO, LOGAN & MEANEY, P.C., 1938 E. OSBORN RD, PHOENIX, AZ, 85016-7234, US

(21) Appl. No.: 11/459,031

(22) Filed: Jul. 21, 2006

Related U.S. Application Data
(60) Provisional application No. 60/595,653, filed on Jul. 25, 2005.

(51) Int. Cl. A23L 1/16

(52) U.S. Cl. 426/143

(57) ABSTRACT

A simple ornamental housing container for table salt sold in standard 26 oz. saltboxes, as described and shown. This allows storage of a larger amount of salt in aesthetically appealing containers to allow quick access to salt in amounts required for daily cooking.

An ornamental container to hold a standard 26 oz. salt can securely and allow easy dispensing without removing from the cardboard grocery can. It can be made from ceramic, glass, wood, plastic, etc.

It consists of a container to house the 26 oz. salt can in and a cap with an orifice of varying designs to allow the hinged saltbox can opening to be accessed for the salt to be dispensed. The container can be one piece with a cap, which can either screw around or inside the container rim based on the aesthetic and functional design. There is also the option of making the can top (with orifice) and the container one piece with a cap below to close the container housing the saltbox. The container cap may be designed with various geometrical shapes so as to allow access to the saltbox hinged opening for salt dispensing. There are also modifications to allow a sliding orifice closing and a hinged closing of the orifice. A simple modification whereby salt can be poured directly into the container with an orifice modification to allow salt dispensing is also part of the this invention.

### SUMMARY

The standard 26 oz. salt can (also known as a saltbox) purchased from a grocery store is a fixture in kitchens. It constitutes a primary seasoning in cooking and is often seen on countertops, only to hidden away due to its appearance. I have devised a container, which can be easily assimilated as a countertop fixture without being “out of place” in aesthetic value. This invention is named SaltBeauty as shown and described.

### BRIEF DESCRIPTION OF THE DRAWINGS

FIG. 1 is a side view of one preferred embodiment of a container and cap.

FIG. 2 is a side view of another preferred embodiment of a container and caps.

FIG. 3 is a top view of one preferred embodiment of a cap.

FIG. 4 is a top view of another preferred embodiment of a cap.

FIG. 5 is a top view of another preferred embodiment of a cap.

FIG. 6 is a side view of another preferred embodiment of a cap.

FIG. 6 is a side view of another preferred embodiment of a cap.

FIG. 7 is a side view of one preferred embodiment of a container and cap.

### DETAILED DESCRIPTION

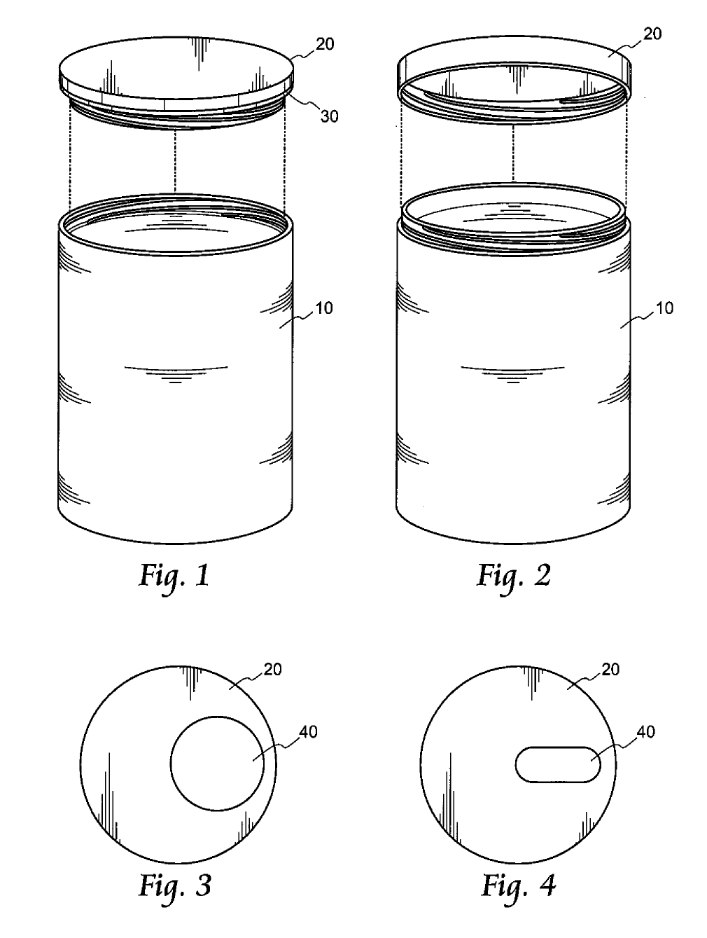

Referring to FIGS. 1 to 7 are preferred embodiments of the invention, one preferred embodiment shown in FIG. 1 shows a container 10 having female threads inside the container 10 and cap 20 having male threads on the cap wherein the cap 20 couples to the top of the container 10. In a more preferred embodiment, a washer 30 may be added to the cap 20 for a tight fit. Another preferred embodiment shown in FIG. 2 shows a container 10 having male threads outside the container 10 and cap 20 having female threads on the cap. In a more preferred embodiment, a washer 30 may be added to the cap 20 for a tight fit as shown in FIG. 1.

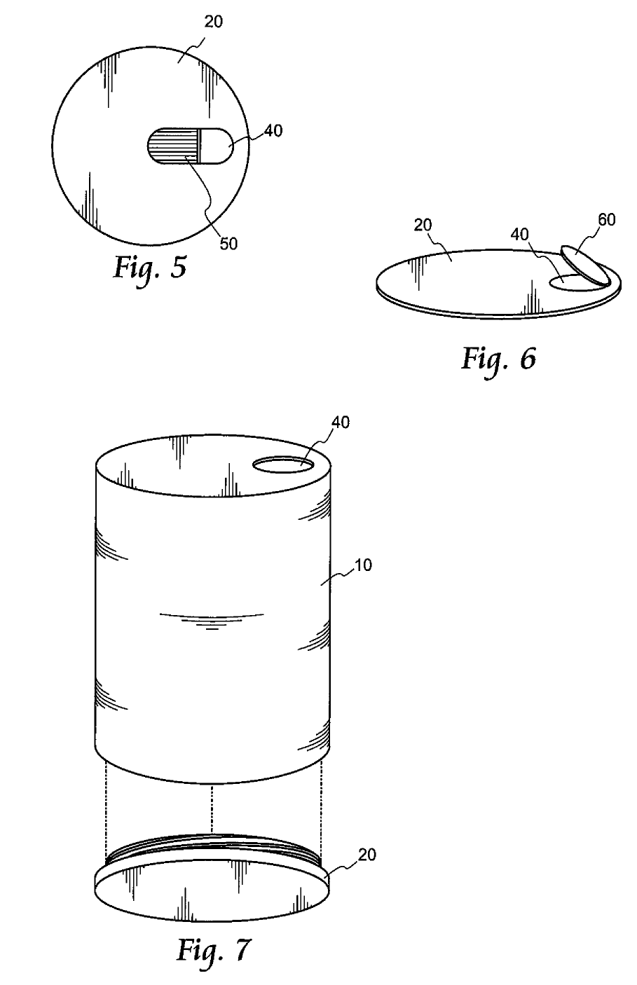

FIG. 3 shows a top view of one preferred embodiment of a cap 10 having, an orifice 40 that is circular. In another preferred embodiment shown in FIG. 4, the cap 20 wherein the orifice 40 is a rectangular orifice. FIG. 5 shows a top view of another preferred embodiment of the cap 10 having the orifice 40 that is the rectangular orifice and further comprising a sliding cover 50 which can be opened and closed by sliding. FIG. 6 shows a side view of another preferred embodiment of the cap 10 having the orifice 40 and further comprising a hinged cover 60 coupled thereto which can be opened and closed.

FIG. 7 shows a one piece container 10 having a cap 20 that screws on from the bottom to secure the salt can into the container. In this preferred embodiment the cap 20 has male threads that screw into the female threads inside the container. As described above in a more preferred embodiment, a washer 30 may be added to the cap 20 for a tight fit. Also as described above in a preferred embodiment, the cap 20 may have female threads and the container 10 may have male threads outside.

1. (canceled)

2. A salt can container comprising: a container coupled to a cap having an orifice.

3. The salt can container of claim 2 wherein the container material is selected from the group consisting of ceramic, glass, wood, plastic and combinations thereof.

4. The salt can container of claim 2 wherein the cap material is selected from the group consisting of ceramic, glass, wood, plastic and combinations thereof.

5. The salt can container of claim 2 wherein the cap further comprises a rubber washer.

6. The salt can container of claim 2 wherein the cap further comprises a sliding orifice cover coupled to the cap.

7. The salt can container of claim 2 wherein the cap further comprises a hinged orifice cover coupled to the cap.

8. The salt can container of claim 2 wherein the cap is coupled to top of the container.

9. The salt can container of claim 2 wherein the cap is coupled to bottom of the container.

10. The salt can container of claim 2 wherein the cap further comprises male threads and the container further comprises female threads that couple to the cap.

11. The salt can container of claim 2 wherein the cap further comprises female threads and the container further comprises male threads that couple to the cap.

12. A method of enhancing a kitchen countertop comprising: placing a salt can in a container coupling a cap having an orifice wherein the orifice allows salt to be dispensed.

13. The method of enhancing a kitchen countertop in claim 12 wherein coupling the cap to the container comprises using threads.

14. The method of enhancing a kitchen countertop in claim 13 further comprises coupling a sliding orifice cover to the cap.

15. The method of enhancing a kitchen countertop in claim 13 further comprises coupling a hinged orifice cover to the cap.
